(19) United States
(12) Patent Application Publication
(10) Pub. No.: US 2025/0229445 A1
(43) Pub. Date: Jul. 17, 2025

(54) SHAVING SYSTEM

(71) Applicant: WENZHOU MEIBO TECHNOLOGY CO., LTD., Wenzhou, Zhejiang (CN)

(72) Inventor: XIANGRONG REN, Wenzhou, Zhejiang (CN)

(21) Appl. No.: 18/849,480

(22) PCT Filed: Mar. 24, 2022
(86) PCT No.: PCT/CN2022/082836

§ 371 Date: Sep. 21, 2024

(51) Int. Cl. B26B 21/28; B26B 21/22

(52) U.S. Cl. CPC B26B 21/28; B26B 21/22

(57) ABSTRACT

A shaving system includes a blade head frame and blades. The blade head frame is provided with a front side wall located in front of the blades, the blades extend in a left-right direction of the blade head frame, and cutting edges of the blades face the front side wall of the blade head frame. The front side wall of the blade head frame is provided with a protective member, and a supporting sidewall between the protective member and the blades, an upper surface of the protective member is 0.05-0.80 mm higher than an upper surface of the supporting sidewall, and the upper surface of the supporting sidewall is 0.01-0.32 mm higher than the cutting edge of the blade adjacent to the supporting sidewall, so as to effectively reduce the skin bulging at the protective member and the blades during shaving, thereby ensuring shaving comfort.

### FIELD OF THE INVENTION

The present application relates to the field of shaving, and particularly to a shaving system which reduces skin bulging to prevent the blades from pressing against and cutting the bulging skin.

### BACKGROUND OF THE INVENTION

A conventional manual razor typically includes a blade head frame, blades, a protective member, a left clip, and a right clip. The blade head frame includes four sidewalls, i.e. a front sidewall, a rear sidewall, a left sidewall, and a right sidewall, which together define a receiving space. At least two blades located within this space, with the left end of each blade embedded in the left sidewall and the right end embedded in the right sidewall from above the blade head frame. The left clip extends across the upper left end of each blade and is fitted to the left sidewall, securing the left end of each blade in place. Similarly, the right clip extends across the upper right end of each blade and is fitted to the right sidewall, securing the right end of each blade. The protective member is mounted on the front sidewall and positioned in front of the blades, with its upper surface flush with the upper surface of the supporting sidewall that is located between the protective member and the blades.

Because the upper surface of the protective member is flush with the upper surface of the supporting sidewall, as shown in FIG. 1, during shaving, both surfaces press down on the elastic skin from the front, while the blade adjacent to the supporting sidewall presses down on the elastic skin from behind. This results in the elastic skin bulging between the supporting sidewall and the adjacent blade, due to the small distance therebetween, causing the blade to press against and cut the bulging skin. While this action removes hair from the skin, it also significantly irritates the skin, leading to discomfort during shaving.

Therefore, there is an urgent need for a shaving system that reduces skin bulging to prevent the blades from pressing against and cutting the bulging skin, to address the aforementioned shortcomings.

### SUMMARY OF THE INVENTION

One objective of the present application is to provide a shaving system which can reduce skin bulging to prevent the blades from pressing against and cutting the bulging skin.

To achieve the above-mentioned objective, a shaving system includes a blade head frame and a blade assembled on the blade head frame. The blade head frame is provided with a front sidewall located in front of the blade, and the blade extends in a left-right direction of the blade head frame, with a cutting edge of the blade facing the front sidewall of the blade head frame. The front sidewall of the blade head frame is provided with a protective member located in front of the blade, and a supporting sidewall between the protective member and the blade, an upper surface of the protective member is higher than an upper surface of the supporting sidewall by 0.05-0.80 mm, and the upper surface of the supporting sidewall is higher than the cutting edge of the blade adjacent to the supporting sidewall by 0.01-0.32 mm.

Preferably, one or more blades are included; when multiple blades are included, the multiple blades are arranged sequentially spaced in a front-back direction of the blade head frame; or the multiple blades are stacked sequentially upward in an up-down direction of the blade head frame and staggered backward.

Preferably, among all the blades arranged sequentially spaced, a reference plane is defined between cutting edges of two blades nearest to the supporting sidewall, with the upper surface of the supporting sidewall being higher than the reference plane by 0.015-0.235 mm.

Preferably, among all the blades arranged sequentially spaced, cutting edges of remaining blades are located within the reference plane.

Preferably, the front sidewall further comprises a separating groove that separates the upper surface of the supporting sidewall from the upper surface of the protective member in the front-back direction of the blade head frame, with the separating groove extending in the left-right direction of the blade head frame.

Preferably, the protective member is provided with multiple recessed grooves that extend in the left-right direction of the blade head frame and are arranged sequentially spaced in the front-back direction of the blade head frame, with the recessed grooves penetrating upward through the upper surface of the protective member.

Preferably, the recessed grooves extend continuously or intermittently, and the recessed grooves also penetrate left and right side surfaces of the protective member.

Preferably, a chamfer structure is provided at front and rear groove walls of the recessed grooves respectively, thereby expanding upper groove openings of the recessed grooves.

Preferably, the protective member and the front sidewall are formed in an integrated unity; or the protective member is connected to the front sidewall in an assembled manner.

Preferably, the shaving system further includes a retainer to clamp the blade together with the blade head frame, with the retainer pressing against the blade from above.

In comparison with the prior art, the upper surface of the protective member is higher than the upper surface of the supporting sidewall, and the upper surface of the supporting sidewall is higher than the cutting edge of the blade adjacent to the supporting sidewall, thus during the shaving process, the protective member presses down on the elastic skin from the front, and the blade adjacent to the supporting sidewall assists in pressing down on the elastic skin from the rear, in such a way, the distance between the pressing positions in the front and rear directions of the elastic skin is reduced, thereby reducing the bulging of the elastic skin. Furthermore, the upper surface of the protective member is higher than the upper surface of the supporting sidewall by 0.05-0.8 mm, and the upper surface of the supporting sidewall is higher than the cutting edge of the blade adjacent to the supporting sidewall by 0.01-0.32 mm, thus it's ensured that the downward pressing of the elastic skin is primarily carried out by the upper surface of the protective member, while the upper surface of the supporting sidewall provides a downward stretch space for the elastic skin in the area between the protective member and the blade. Additionally, since the upper surface of the supporting sidewall is higher than the cutting edge of the blade adjacent to the supporting sidewall by 0.01-0.32 mm, which effectively prevents the elastic skin from protruding downward over the cutting edge of the blade adjacent to the supporting sidewall during the downward stretch process, thereby avoiding the cutting edge from pressing against and cutting the elastic skin. As a result, the cutting edge of the blade adjacent to the supporting sidewall smoothly cuts the hair on the elastic skin, thereby reducing irritation or even cuts to the elastic skin, and finally ensuring shaving comfort.

### BRIEF DESCRIPTION OF THE DRAWINGS

FIG. 1 is a state diagram of a conventional razor during shaving, showing the relationship between the razor and the elastic skin.

FIG. 2 is a perspective view of the shaving system according to the present application.

FIG. 3 is a top-down plan view of the shaving system shown in FIG. 2.

FIG. 4 is an internal view along the D-D line in FIG. 3.

FIG. 5 is a state diagram of the shaving system according to the present application during shaving, showing the relationship between the shaving system and the elastic skin.

FIG. 6 is a plan view of the protective member in the shaving system according to a modified embodiment of the present application.

FIG. 7 is a plan view of the protective member in the shaving system according to another modified embodiment of the present application.

FIG. 8 is a plan view of the protective member in the shaving system according to one more modified embodiment of the present application.

FIG. 9 is an internal view showing the shaving system according to a modified embodiment of the present application.

### DETAILED DESCRIPTION OF ILLUSTRATED EMBODIMENTS

To explain the technical content and structural features of the present application in detail, the following description is made in conjunction with the embodiments and accompanying drawings.

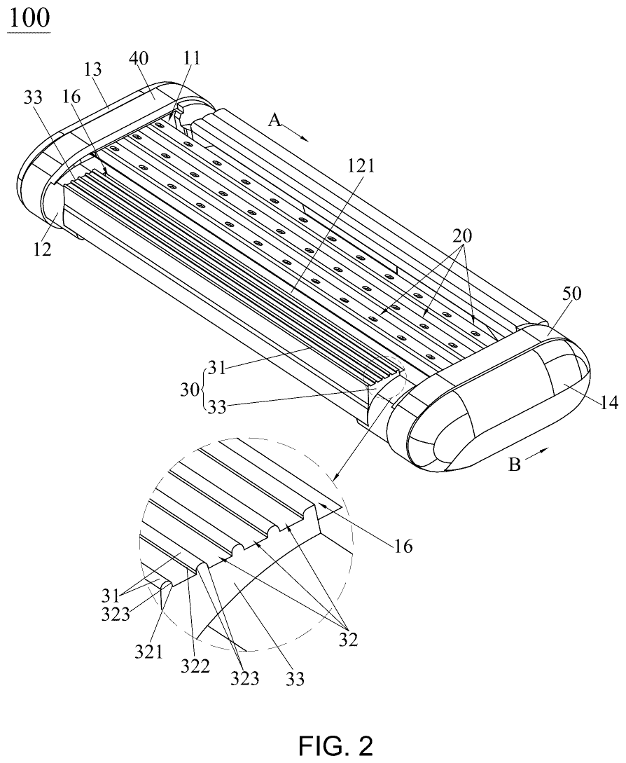

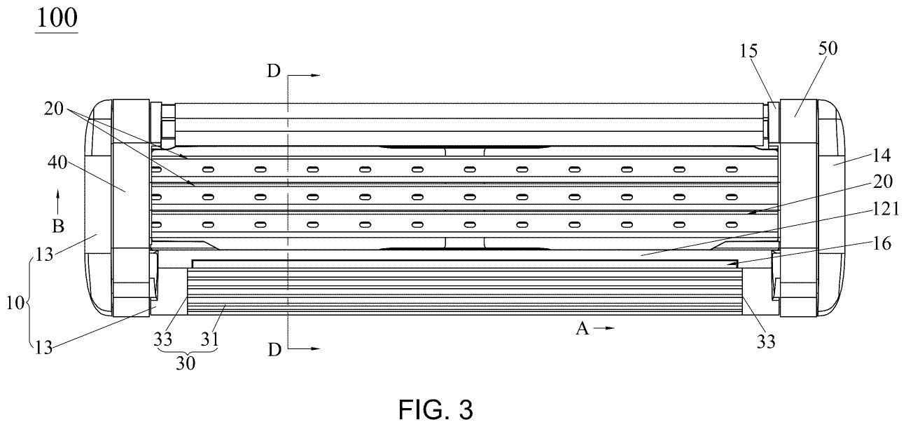

Referring to FIGS. 2, 3, and 5, the shaving system 100 of the present application includes a blade head frame 10 with a containing space 11 and blades 20 positioned within the containing space 11. This arrangement facilitates the removal of hair 320 shaved off by the blades 20 from the containing space 11 and allows for easy cleaning of the blades 20. The basic contour of the blade head frame 10 is square, and the shape of the containing space 11 matches the external contour of the blade head frame 10, that is, the containing space 11 is also square. Of course, depending on actual needs, the basic contour of the blade head frame 10 could be other shapes, which is not limited to that shown in FIGS. 2 and 3.

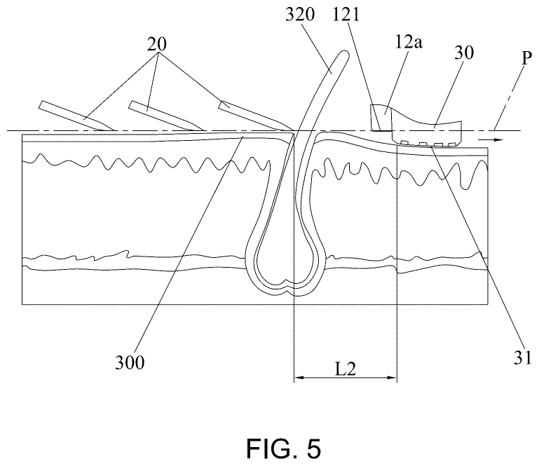

Three blades 20 are configured in the embodiment, and arranged sequentially along the front-to-back direction of the blade head frame 10. Optionally, the number of blades 20 can be one, two, four, or more, depending on actual needs, which is not limited to that shown in FIGS. 2 to 4. The blades 20 also extend along the left-to-right direction of the blade head frame 10, so that the length of the blades 20 matches the length of the blade head frame 10. The cutting edges 21 of the blades 20 face the front sidewall 12 of the blade head frame 10 to meet the need for shaving hair 320 on the elastic skin 300 when the blade head frame 10 slides from its rear sidewall 15 to the front sidewall 12, as shown in FIG. 5. The left ends of the blades 20 are assembled to the left sidewall 13 of the blade head frame 10. Preferably, the left ends of the blades 20 are embedded into the left sidewall 13 from above the blade head frame 10, with the left sidewall 13 providing assembly and support for the left ends of the blades 20 and preventing the left ends of the blades 20 from moving erratically along the front-to-back direction of the blade head frame 10 relative to the left sidewall 13. Similarly, the right ends of the blades 20 are assembled to the right sidewall 14 of the blade head frame 10. Preferably, the right ends of the blades 20 are embedded into the right sidewall 14 from above the blade head frame 10, with the right sidewall 14 providing assembly and support for the right end of the blades 20 and preventing the right end of the blades 20 from moving erratically along the front-to-back direction of the blade head frame 10 relative to the right sidewall 14. Therefore, with the combined action of the left sidewall 13 and the right sidewall 14, the blades 20 are prevented from moving erratically along the front-to-back direction of the blade head frame 10, ensuring the reliability of the blades 20 in shaving hair 320 as the blade head frame 10 moves from back to front.

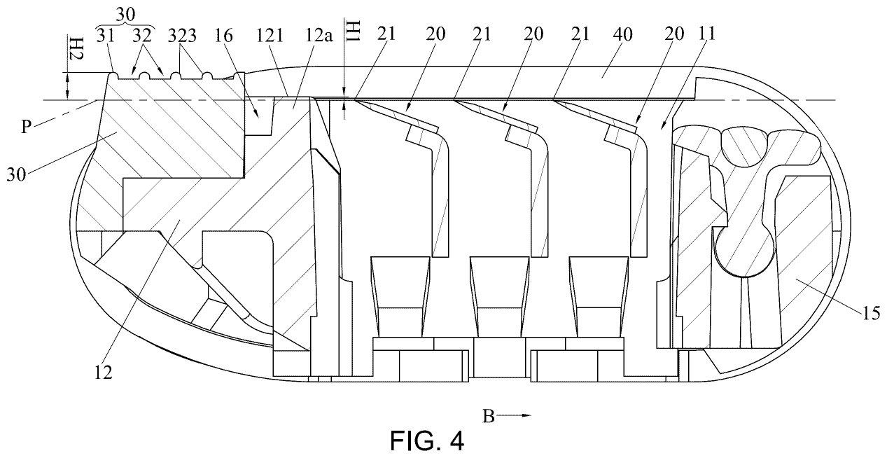

Referring to FIG. 4, the front sidewall 12 of the blade head frame 10 includes a protective member component 30 located in front of the blades 20 and a supporting sidewall 12a located between the protective member 30 and the blades 20. The upper surface 31 of the protective member 30 is higher than the upper surface of the supporting sidewall 12a by 0.05-0.80 mm. For example, the upper surface 31 of the protective member 30 is higher than the upper surface of the supporting sidewall 12a by 0.05 mm, 0.10 mm, 0.20 mm, 0.30 mm, 0.40 mm, 0.50 mm, 0.60 mm, 0.70 mm, or 0.80 mm. The upper surface 121 of the supporting sidewall 12a is higher than the cutting edge of the blade 20 adjacent to the supporting sidewall 12a by 0.01-0.32 mm. For example, the upper surface 121 of the supporting sidewall 12a is higher than the cutting edge of the blade 20 adjacent to the supporting sidewall 12a by 0.01 mm, 0.05 mm, 0.10 mm, 0.15 mm, 0.20 mm, 0.25 mm, or 0.32 mm. This arrangement prevents the distance between the upper surface 31 of the protective member 30 and the upper surface 121 of the supporting sidewall 12a from being too small, which would cause excessive irritation of the cutting edge 21 to the elastic skin 300, or the distance from being too large, which would disenables the cutting edge 21 to shave the hair 320 on the elastic skin 300.

Specifically, as shown in FIG. 4, the protective member 30 and the front sidewall 12 are formed in an integrated unity. For example, the protective member 30 and the blade head frame 10 can be integrally molded through dual-shot injection molding, where the blade head frame 10 is molded first, followed by the protective member 30 at the front sidewall 12 of the blade head frame 10. Alternatively, the protective member 30 can be embedded as an insert into the mold, with the mold forming the blade head frame 10 and the protective member 30 as a single unit. Of course, the protective member 30 may also be connected to the front sidewall 12 through assembly methods such as gluing, ultrasonic welding, or mechanical interlocking.

More specifically, as shown in FIG. 4, the cutting edges 21 of the two blades closest to the supporting sidewall 12a define a reference plane P. The upper surface 121 of the supporting sidewall 12a is 0.015-0.235 mm higher than the reference plane P. For example, the upper surface 121 of the supporting sidewall 12a is higher than the reference plane by 0.015 mm, 0.15 mm, 0.18 mm, 0.20 mm, or 0.235 mm. The cutting edges 21 of the remaining blades are also located on the reference plane P, so that there is no height difference among the cutting edges 21 of the three blades 20. Optionally, depending on actual needs, the cutting edge 21 of the blade furthest from the supporting sidewall 12a may not locate on the reference plane P, thereby creating a height difference between the cutting edge 21 of the blade furthest from the supporting sidewall 12a and the cutting edges of the two blades closest to the supporting sidewall 12a. In other words, the planes defined by the cutting edges 21 of any two of the three blades 20 will not coincide. Specifically, in FIG. 4, the cutting edges 21 of all the blades 20 are parallel, so that the cutting edges 21 of any two blades 20 are coplanar and parallel. Optionally, depending on actual needs, the cutting edges 21 of any two blades 20 may be coplanar but not parallel. It should be noted that the height of the upper surface 121 of the supporting sidewall 12a above the reference plane P by 0.015-0.235 mm refers to the vertical distance H1 from the highest point of the upper surface 121 of the supporting sidewall 12a to the reference plane P. When there is only one blade 20, the height of the upper surface 121 of the supporting sidewall 12a above the cutting edge of the blade 20 by 0.01-0.32 mm refers to the vertical distance from the highest point of the upper surface 121 of the supporting sidewall 12a to the horizontal plane passing through the cutting edge 21 of the blade 20. It is understood that, since the upper surface 31 of the protective member 30 is higher than the upper surface 121 of the supporting sidewall 12a, when there are two or more blades 20, the height of the upper surface 31 of the protective member 30 above the upper surface 121 of the supporting sidewall 12a is the vertical distance H2 from the highest point of the upper surface 31 of the protective member 30 to the reference plane P minus the vertical distance H1 from the highest point of the upper surface 121 of the supporting sidewall 12a to the reference plane P, as shown in FIG. 4. When there is only one blade 20, the height of the upper surface 31 of the protective member 30 above the upper surface 121 of the supporting sidewall 12a is the vertical distance from the highest point of the upper surface 31 of the protective member 30 to the horizontal plane passing through the cutting edge 21 of the blade 20 minus the vertical distance from the highest point of the upper surface 121 of the supporting sidewall 12a to the horizontal plane passing through the cutting edge 21 of the blade 20.

As shown in FIGS. 2 to 4, the front sidewall 12 further includes a separating groove 16, which separates the upper surface 121 of the supporting sidewall 12a from the upper surface 31 of the protective member 30 in the front-back direction of the blade head frame 10. The separating groove 16 extends in the left-right direction of the blade head frame 10. By introducing the separating groove 16, the hairs 320, which are flattened by the upper surface 31 of the protective member 30, are able to stand upright at the location of the separating groove 16. This ensures that the cutting edges 21 of the subsequent blades 20 can effectively shave the hairs 320. Specifically, in FIG. 3, the left and right ends of the protective member 30 extend beyond the same end of the separating groove 16, making the protective member 30 slightly longer than the separating groove 16. In such arrangements, it's ensured that the hairs 320 standing upright within the separating groove 16 have been flattened by the upper surface 31 of the protective member 30.

As shown in FIGS. 2 and 4, the protective member 30 is provided with multiple recessed grooves 32 that extend in the left-right direction of the blade head frame 10 and are spaced apart in the front-back direction of the blade head frame 10. These recessed grooves 32 penetrate upward through the upper surface 31 of the protective member 30, making the upper surface 31 of the protective member 30 relatively softer compared to the blade head frame 10, and resulting in a more comfortable contact with the elastic skin 300 during the process of tightening the elastic skin 300. Specifically, in FIGS. 2 and 4, the recessed grooves 32 extend continuously and also penetrate the left and right side surfaces 33 of the protective member 30, thereby ensuring uniform softness across all positions on the upper surface 31 of the protective member 30. Optionally, depending on actual needs, the recessed grooves 32 may also extend intermittently, that is, the recessed grooves 32 includes multiple separated sections, which is not limited to the configurations shown in FIGS. 2 and 4. More specifically, in FIGS. 2 and 4, a front groove wall 321 and a rear groove wall 322 of the recessed grooves 32 each have chamfer structures 323 for widening the upper openings of the recessed grooves 32. This configuration makes the front groove wall 321 and rear groove wall 322 smoother, thereby improving the comfort of the protective member 30 contacting with the elastic skin 300 and avoiding severe irritation to the elastic skin 300 due to sharp edges or other sharp structures.

As shown in FIGS. 2 to 4, the shaving system 100 in the present application further includes a retainer used to clamp the blade 20 together with the blade head frame 10. The retainer presses against the blade 20 from above. Specifically, the retainer includes a left retainer 40 and a right retainer 50. The left retainer 40 spans the left ends of the blades 20 from above and is mounted on the left sidewall 13 of the blade head frame 10. The left retainer 40 and the left sidewall 13 of the blade head frame 10 together clamp the left ends of the blades 20 to prevent them from accidentally sliding upward out of the left sidewall 13, thus ensuring that the left ends of the blades 20 functions within the position defined by the left sidewall 13 and the left retainer 40. The right retainer 50 spans the right ends of the blades 20 from above and is mounted on the right sidewall 14 of the blade head frame 10. The right retainer 50 and the right sidewall 14 of the blade head frame 10 together clamp the right ends of the blades 20 to prevent them from accidentally sliding upward out of the right sidewall 14, thus ensuring that the right ends of the blades 20 functions within the position defined by the right sidewall 14 and the right retainer 50. Specifically, in FIGS. 2 and 3, the left retainer 40 and right retainer 50 are each independent sheet-like structures. Optionally, depending on actual needs, the left retainer 40 and right retainer 50 may also be integrated into a single sheet-like structure, which are not limited to the configurations shown in FIGS. 2 to 4. By using the left retainer 40 and right retainer 50 to surround the left sidewall 13 and the right sidewall 14 respectively, the process of mounting and dismounting the blades 20 in the blade head frame 10 is simplified.

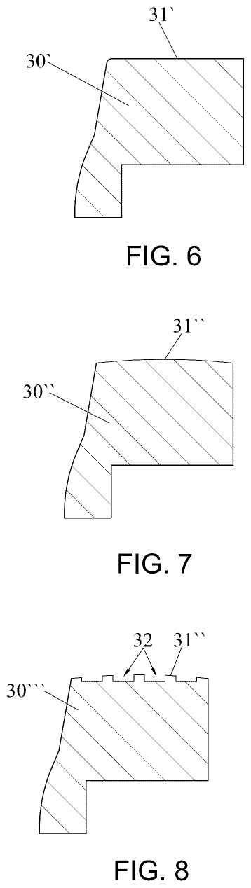

Referring to FIG. 6, a protective member according to another embodiment is shown. As illustrated, the protective member 30′ provides no recessed grooves 32, so the protective member 30′ has a continuous upper surface 31′ which is flat. Whereas in FIG. 4, the protective member 30 has multiple recessed grooves 32, thus the upper surface 31 of the protective member 30 is discontinuous and partitioned. That's, the upper surface 31′ in FIG. 6 is a flat surface, which provides a straight top line has in its cross section.

Referring to FIG. 7, a protective member according to one more modified embodiment is shown. As illustrated, the difference between the protective member 30″ in FIG. 7 and the protective member 30′ in FIG. 6 lies in the shape of their upper surfaces. In FIG. 7, the upper surface 31″ of the protective member 30″ is an arched curved surface, that is, the upper surface 31″ of the protective member 30″ provides an arc in its cross section; whereas in FIG. 6, the upper surface 31′ of the protective member 30′ is a flat surface, which provides a straight top line has in its cross section.

Referring to FIG. 8, a protective member according to yet another modified embodiment is shown. In FIG. 8, the protective member 30″′ provides more recessed grooves 32 than the protective member 30″ shown in FIG. 7, with a total of four recessed grooves 32. Optionally, the number of the recessed grooves 32 may be adjusted as needed, which is not limited here.

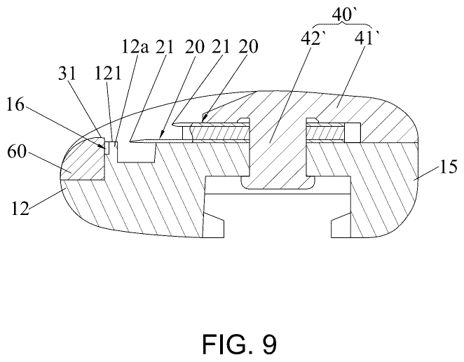

Referring to FIG. 9, the shaving system according to a modified embodiment of the present application. The shaving system in this embodiment is essentially the same as that previously described, with the following differences.

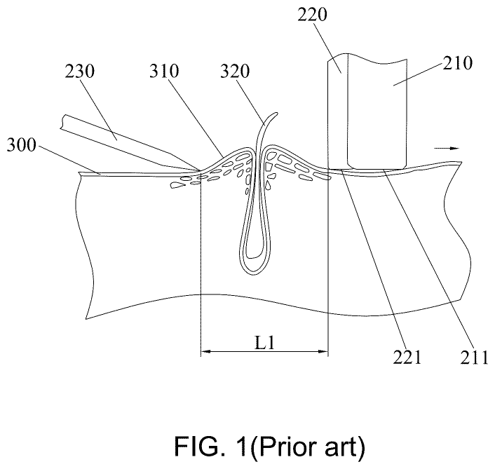

First, in the modified embodiment, all the blades 20 are stacked upwards in the up-down direction of the blade head frame 10 and staggered backwards. This arrangement ensures that the lower blade 20 of two adjacent stacked blades 20 protrudes forward from the upper blade 20, thereby ensuring that the hairs 320 on the elastic skin 300 are first shaved by the lower blade 20 and then by the upper blade 20. In the shaving system 100 shown in FIGS. 1 to 4, all the blades 20 are arranged in sequence along the front-back direction of the blade head frame 10.

Second, in the modified embodiment, the retainer 40′ includes a pressing cover 41′ that presses the blades 20 from above and a rivet structure 42′ that extends downward from the pressing cover 41′ through the blade 20 and the blade head frame 10. By means of the rivet structure 42′ and the pressing cover 41′, the blades 20 is fixed with the blade head frame 10 together, thereby preventing undesired movements of the blades 20 within the blade head frame 10. In the shaving system 100 shown in FIGS. 1 to 4, the retainer includes a left retainer 40 and a right retainer 50. The left retainer 40 spans the left ends of the blade 20 from above and is mounted on the left sidewall 13 of the blade head frame 10. The left retainer 40 and the left sidewall 13 of the blade head frame 10 together clamp the left ends of the blades 20 to prevent them from accidentally sliding upward out of the left sidewall 13, thus ensuring that the left ends of the blades 20 function within the position defined by the left sidewall 13 and the left retainer 40. The right retainer 50 spans the right ends of the blades 20 from above and is mounted on the right sidewall 14 of the blade head frame 10. The right retainer 50 and the right sidewall 14 of the blade head frame 10 together clamp the right ends of the blades 20 to prevent them from accidentally sliding upward out of the right sidewall 14, thus ensuring that the right ends of the blades 20 function within the position defined by the right sidewall 14 and the right retainer 50.

Third, in the modified embodiment, the blade head frame 10 provides no receiving space 11. While in the shaving system 100 shown in FIGS. 1 to 4, the blade head frame 10 includes the receiving space 11, which allows the blades 20 to be suspended within the receiving space 11 between their left and right ends.

Fourth, in the modified embodiment, the protective member 60 has a cross-section in a quarter-circle shape. Optionally, the protective member 60 may be the protective member 30 shown in FIGS. 2 and 4, or may be the protective member 30′ (30″, 30″′) shown in FIGS. 6 to 8.

Fifth, in the modified embodiment, the left ends of the blades 20 are not assembled to the left sidewall 13, and the right ends of the blades 20 are not assembled to the right sidewall 14. Instead, the blades 20 are stacked onto the blade head frame 10 from above. While in the shaving system 100 shown in FIGS. 1 to 4, the left ends of the blades 20 are assembled to the left sidewall 13, and the right ends of the blades 40 are assembled to the right sidewall 14.

Except for the foregoing differences, the other structures for the both embodiments are the same and will not be repeated here.

In summary, the shaving system 100 of the present application includes the blade head frame 10 and the blade 20 mounted on the blade head frame 10 in a manner as previously described or other manners not described. The blade head frame 10 has a front sidewall 12 located in front of the blade 20, with the blade 20 extending in the left-right direction of the blade head frame 10. The cutting edge 21 of the blade 20 faces the front sidewall 12 of the blade head frame 10. The front sidewall 12 of the blade head frame 10 includes a protective member 30 positioned in front of the blade 20 and a supporting sidewall 12a situated between the protective member 30 and the blade 20. The upper surface 31 of the protective member 30 is 0.05-0.80 mm higher than the upper surface 121 of the supporting sidewall 12a, and the upper surface 121 of the supporting sidewall 12a is 0.01-0.32 mm higher than the cutting edge 21 of the blade 20 adjacent to the supporting sidewall 12a.

Compared with the prior art, the upper surface 31 of the protective member 30 is higher than the upper surface 121 of the supporting sidewall 12a, and the upper surface 121 of the supporting sidewall 12a is higher than the cutting edge 21 of the blade 20 adjacent to the supporting sidewall 12a, thus during the shaving process in the direction indicated by the arrow in FIG. 5, the protective member 30 presses down on the elastic skin 300 from the front, and the blade 20 adjacent to the supporting sidewall 12a assists in pressing down on the elastic skin 300 from the rear, in such a way, the distance L2 between the pressing positions in the front and rear directions of the elastic skin 300 is reduced, thereby reducing the bulging of the elastic skin 300. Furthermore, the upper surface 31 of the protective member 30 is higher than the upper surface 121 of the supporting sidewall 12a by 0.05-0.8 mm, and the upper surface 121 of the supporting sidewall 12a is higher than the cutting edge 21 of the blade 20 adjacent to the supporting sidewall 12a by 0.01-0.32 mm, thus it's ensured that the downward pressing of the elastic skin 300 is primarily carried out by the upper surface 31 of the protective member 30, while the upper surface 121 of the supporting sidewall 12a provides a downward stretch space for the elastic skin 300 in the area between the protective member 30 and the blade 20. Additionally, since the upper surface 121 of the supporting sidewall 12a is higher than the cutting edge 21 of the blade 20 adjacent to the supporting sidewall 12a by 0.01-0.32 mm, it effectively prevents the elastic skin 300 from protruding downward over the cutting edge 21 of the blade 20 adjacent to the supporting sidewall 12a during the downward stretch process, thereby avoiding the cutting edge 21 from pressing against and cutting the elastic skin 300. As a result, the cutting edge 21 of the blade 20 adjacent to the supporting sidewall 12a smoothly cuts the hair 320 on the elastic skin 300, thereby reducing irritation or even cuts to the elastic skin 300, and finally ensuring shaving comfort.

It is worth noting that in the drawings, the direction indicated by arrow A is the left-to-right direction of the blade head frame 10, and the direction indicated by arrow B is the front-to-back direction of the blade head frame 10. Additionally, during the shaving process, the protective member 30, through relative sliding friction with the elastic skin 300, tightens the elastic skin 300 and flattens the hair 320 on the elastic skin 300. The protective member 30 may be made of thermoplastic elastomers or rubber, while the blade head frame 10 may be made of plastic, such as ABS. Furthermore, the receiving space 11 is defined by the front sidewall 12, rear sidewall 15, left sidewall 13, and right sidewall 14 of the blade head frame 10. Finally, although the pressing cover 41′ and the rivet structure 42′ are shown in integrated unity in FIG. 9, they can also be made as separate structures according to actual needs, which are not limited those shown in FIG. 9.

The above disclosure is only exemplary embodiments of the present application, and it should not be construed to limit the scope of the present application. Therefore, equivalent changes made according to the claims of the present application are still within the scope covered by the present application.

What is claimed is:

1. A shaving system, comprising a blade head frame and a blade assembled on the blade head frame, wherein the blade head frame is provided with a front sidewall located in front of the blade, and the blade extends in a left-right direction of the blade head frame, with a cutting edge of the blade facing the front sidewall of the blade head frame, the front sidewall of the blade head frame is provided with a protective member located in front of the blade, and a supporting sidewall between the protective member and the blade, an upper surface of the protective member is higher than an upper surface of the supporting sidewall by 0.05-0.80 mm, and the upper surface of the supporting sidewall is higher than the cutting edge of the blade adjacent to the supporting sidewall by 0.01-0.32 mm.

2. The shaving system according to claim 1, wherein one or more blades are included; when multiple blades are included, the multiple blades are arranged sequentially spaced in a front-back direction of the blade head frame; or the multiple blades are stacked sequentially upward in an up-down direction of the blade head frame and staggered backward.

3. The shaving system according to claim 2, wherein, among all the blades arranged sequentially spaced, a reference plane is defined between cutting edges of two blades nearest to the supporting sidewall, with the upper surface of the supporting sidewall being higher than the reference plane by 0.015-0.235 mm.

4. The shaving system according to claim 3, wherein, among all the blades arranged sequentially spaced, cutting edges of remaining blades are located within the reference plane.

5. The shaving system according to claim 1, wherein the front sidewall further comprises a separating groove that separates the upper surface of the supporting sidewall from the upper surface of the protective member in the front-back direction of the blade head frame, with the separating groove extending in the left-right direction of the blade head frame.

6. The shaving system according to claim 1, wherein the protective member is provided with multiple recessed grooves that extend in the left-right direction of the blade head frame and are arranged sequentially spaced in the front-back direction of the blade head frame, with the recessed grooves penetrating upward through the upper surface of the protective member.

7. The shaving system according to claim 6, wherein the recessed grooves extend continuously or intermittently, and the recessed grooves also penetrate left and right side surfaces of the protective member.

8. The shaving system according to claim 7, wherein a chamfer structure is provided at front and rear groove walls of the recessed grooves respectively, thereby expanding upper groove openings of the recessed grooves.

9. The shaving system according to claim 1, wherein the protective member and the front sidewall are formed in an integrated unity; or the protective member is connected to the front sidewall in an assembled manner.

10. The shaving system according to claim 1, further comprising a retainer to clamp the blade together with the blade head frame, with the retainer pressing against the blade from above.
